(19) United States
(12) Patent Application Publication
(10) Pub. No.: US 2009/0254900 A1
(43) Pub. Date: Oct. 8, 2009

(54) NETWORK SYSTEM, COMPUTERS, AND METHOD AND PROGRAM FOR PROVIDING AND EXECUTING APPLICATIONS IN NETWORK SYSTEM

(75) Inventor: Hideo Nakamura, Nagano-ken (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku, Tokyo (JP)

(21) Appl. No.: 12/373,516

(22) PCT Filed: Jun. 15, 2007
(86) PCT No.: PCT/JP2007/000636

§ 371 Date: Jan. 12, 2009

(30) Foreign Application Priority Data
Jul. 13, 2006 (JP) 2006-192733
Oct. 2, 2006 (JP) 2006-270454

(51) Int. Cl. G06F 9/445; G06F 15/173

(52) U.S. Cl. 717/176; 709/226

(57) ABSTRACT

To provide a network system or the like that makes it possible for a client terminal to use an application without being influenced by the quality of circuits or the like and having a simple configuration, and that also makes it possible for a user to easily search a desired application. In a network system 1, application provider servers 2, application execution units 4, an administration server 3 are connected through an external network 6, and one of the application execution units 4 and client terminals 5 are connected through an internal network 7. The administration server 3 provides the application execution units 4 with information on the applications provided from the application provider servers 2. The application execution unit 4 selects a desired application based on the information on the acquired applications and executes the desired application based on a request from one of the client terminals 5.

### TECHNICAL FIELD

The present invention relates to a network system and computers providing applications through a local area network (LAN), the Internet or other communication networks, and a method and program for providing and executing applications in such a network system.

### BACKGROUND ART

In recent years, such a type of network system in which servers provide application services to each terminal connected to the Internet has been known. In such a network system, users execute applications stored on a server to acquire execution results (output data) by accessing the server from terminals through the Internet (see Patent Document 1).

### [Patent Document 1] JP-A-2003-186380

### DISCLOSURE OF THE INVENTION

### Problems to be Solved

Such a network system, however, has involved a problem that simultaneous access from a large number of terminals to a server causes an intense load on the server, resulting in insufficient response speed. Unstable connections have also caused to interrupt communication, resulting in insufficient response speed as the above. Also, if the server is down or the network is disconnected, users' operations are interrupted until the system recovers. Especially, running processes requiring real-time performance of servers in such a system poses risk on users. A redundant configuration, such as dual servers and connections, can solve such troubles. In this situation, however, equipment cost increases due to a change of device configurations, an addition or change of connections and any other change, thereby making the system more complicated.

Further, if users like to be provided with applications from a plurality of application providers, they need to access each application provider's server individually to search for a desired application, which has been a troublesome operation.

In view of the above-described problems, the present invention provides a network system and computers that allow client terminals to use application services in a simple configuration and allow users to search for desired applications smoothly without being affected by server performance or connection quality, and a method and program for providing and executing applications in such a network system.

### Means to Solve the Problems

A network system according to the present invention is a network system in which one or more application provider servers providing applications, application execution units executing the applications acquired from the application provider servers and a single administration server managing the application provider servers and application execution units remotely are connected through an external network and in which an application execution unit and client terminals requesting the application execution unit to execute the applications are connected through an internal network. The administration server provides the application execution units with information on the applications provided from the application provider servers, and the application execution unit selects a desired application based on the information on the applications acquired from the administration server and executes the desired application based on a request from a client terminal.

In this situation, it is preferable that the administration server include an application catalog storage storing an application catalog that lists a plurality of applications provided from the application provider servers as information relating to the applications, and an application catalog sender sending the application catalog to the application execution units. It is also preferable that the application execution unit include an application selector selecting an application from a plurality of applications that are listed in the application catalog received from the administration server, an application acquisitor acquiring the application selected by the application selector from the application provider server, an application storage storing the acquired application and an application executor executing an application that is stored in the application storage. It is also preferable that the client terminal include an execution requester requesting the application execution unit to execute an application stored in the application storage.

A method for providing applications in a network system according to the present invention is a method for providing applications in a network system in which one or more application provider servers that provide applications, application execution units that execute the applications acquired from the application provider servers and a single administration server that manages the application provider servers and the application execution units remotely are connected through an external network and in which an application execution unit and client terminals are connected through an internal network. In the network system, the administration server stores an application catalog listing information on a plurality of applications provided from the application provider servers. The administration server sends the application catalog to the application execution unit. The application execution unit selects an application from a plurality of applications listed in the application catalog that is received from the administration server and acquires the chosen application from the application provider server. The application execution unit stores the acquired application and executes the stored application based on an execution request from a client terminal.

With this configuration, a client terminal can acquire an application execution result by accessing the application execution unit connected through the internal network without going through an external network, such as the Internet. This allows limiting an application execution environment to an internal network, which makes it possible to execute applications in a stable environment. This means that there is no need to adopt a redundant configuration with failures taken into consideration, which eliminates a need to construct a complicated network system and reduces equipment costs.

The application catalog is sent by the application catalog sender from the application provider server, which allows a user (application execution unit) to select a desired application from the application catalog and search for the application smoothly, and widens the choice of applications.

In this situation, it is preferable that the administration server is connected with a plurality of application execution units for respective users, and the administration server also include an application usage information storage storing application usage information that associates a given application out of a plurality of applications provided from the application provider servers with the application execution units provided with the application. It is also preferable that the application catalog sender, based on the application usage information, send the application execution units the application catalog that varies from user to user.

With this configuration, the application catalog that lists given applications set for each user based on the application usage information is sent to each user (application execution unit). In other words, since the application catalog that does not list information on applications that are not supposed to be provided is sent, a user can select a desired application smoothly.

In this situation, it is preferable that the administration server also include an application selecting agent that selects an application in place of the application selector included in the application execution unit. It is also preferable that the application acquisitor included in the application execution unit acquire the application selected by the application selecting agent.

With this configuration, the application execution unit can acquire the application from the application provider server easily by bypassing the application selector. This means that the application execution unit automatically acquires the application selection by the administration server, which saves the user selecting the application. This allows the administration server to manage applications to be introduced to the application execution units. The information on application selection by the application selecting agent may be sent by the administration server concurrently with the application catalog or being included in the application catalog.

In this situation, it is preferable that the application execution unit also include a terminal executability information storage storing terminal executability information that defines executability of applications for each client terminal, a terminal identifier identifying a client terminal that has requested execution of an application and a terminal executability determiner determining executability of the application based on the terminal executability information and an identification result given by the terminal identifier. It is also preferable that the application executor execute the application only when the terminal executability determiner determines that it is executable.

With this configuration, the application execution unit does not execute the application on an execution request from a client terminal that are not allowed to use the application, which prevents unauthorized access from client terminals. This allows controlling applications executable for each client terminal, which enables each client terminal to specialize in a particular function.

In this situation, it is preferable that the application execution unit also include a terminal management information storage storing terminal management information of the client terminals connected to the same internal network, a terminal management information reviser revising the terminal management information when a change of the client terminals connected to the internal network occurs and a terminal management information sender sending the terminal management information to the administration server.

With this configuration, the administration server can oversee connections from the client terminals to the internal network by receiving from the application execution unit the terminal management information of the client terminals connected to the internal network. For this reason, when the administration server detects that a client terminal has been disconnected from the internal network, for example, the server administrator of the administration server can ask the user of the client terminal for confirmation, which allows for earlier troubleshooting.

In this situation, it is preferable that the application execution unit also include a user executability information storage storing user executability information that defines executability of applications for each user of a client terminal, a user identifier identifying a user who has requested execution of the application and a user executability determiner determining executability of an application based on the user executability information and an identification result given by the user identifier. It is also preferable that the application executor execute an application only when the user executability determiner determines that it is executable.

With this configuration, the application execution unit does not execute the application on an execution request from a user who is not allowed to use the application, which prevents unauthorized access from those who are not users (outsiders). This allows controlling applications executable for each user, which makes it possible to construct a system that is flexible and independent from the use of client terminals.

In this situation, it is preferable that the application execution unit also include a user management information storage storing user management information of users using an application, a user management information reviser revising the user management information when a change of users occurs and a user management information sender sending the user management information to the administration server.

With this configuration, the administration server can oversee access by users to the application execution units by receiving from the application execution units the user management information of the users (client terminals) accessing the application execution units. This allows for strict management of application execution per user.

In this situation, it is preferable that the application execution unit also include a usage overview storage storing an overview of application usage by the client terminals connected to the same internal network and a usage overview sender sending the overview of application usage to the administration server.

With this configuration, the administration server can manage the usage (the type of application used, usage time duration, processed data volume and the like) of applications used in the application execution units. For this reason, when the administration server is expected to control the time duration of application usage or the volume of data processed in each application execution unit, for example, it can control the usage by informing a client terminal that has exceeded a given limit of usage thereof or taking any other action.

In this situation, it is preferable that the administration server also include a rate information generator generating rate information for each user based on the overview of application usage that has been received.

With this configuration, the administration server can generate rate information for each user and yield profits based on the rate information.

If the administration server is configured so as to be capable of acquiring the information that specifies applications used by each user, it can pay the charges for application supply to application providers. This eliminates a need for application providers to manage the rate information, which can reduce their burden.

In this situation, it is preferable that each application stored in the application storage be given precedence information on precedence in execution of the application. It is also preferable that the application executor execute the applications in order based on the precedence information when requests for execution of a plurality of applications are made from the client terminals.

With this configuration, the application executor executes applications in order of precedence in execution even when requests for execution of a plurality of applications are made from the client terminals concurrently; for example, giving precedence in execution to an application that is used for more important processes allows the client terminals to run more important processes earlier even when too many execution requests are made.

In this situation, it is preferable that the application execution unit also include an application extender extending a plurality of applications acquired by the application acquisitor by linking and executing them.

With this configuration, applications can be used extensively. For example, it is possible to link the applications for business trip management and transportation schedules and to provide an extended application that supplies information on travel expenses incurred and transportation used on business trips.

In this situation, it is preferable that the application execution unit also include an output data sender sending the application provider server or administration server output data that are output through execution of an application by the application executor.

With this configuration, the application provider server or administration server can use the output data sent by the application execution units for other processes. Acquiring purchased item information output by POS application execution, for example, the application provider server or administration server can run sales management processes.

In this situation, it is preferable that the application execution unit also include a server execution requester requesting a given server to run processes.

With this configuration, it is possible to configure an optimized execution environment in the network system if places that are required to execute an application are changed according to the application type. For example, the requests that need to be processed by the administration server or application provider server in real time can be made thereto; and those which do not need to can be processed by the application execution unit.

In this situation, it is preferable that an application play a role of a device driver.

With this configuration, if a peripheral device is connected to a client terminal, there is no need to install the device driver for the peripheral device on each client terminal.

In this situation, it is preferable that the application provider server provide an application execution set that is a set of an application and one or more databases used on execution of the application. It is also preferable that the application execution unit also include an execution set acquisitor acquiring the application execution set from the application provider server, an execution set storage storing a plurality of acquired application execution sets, a plurality of application execution environments that are formed of a container built for each application execution set as an operating environment for the application and a database engine accessing at least one of the databases based on operations of the application and an execution set executor executing in each application execution environment the application execution set stored in the application storage. It is also preferable that the client terminal include an execution requester requesting the application execution unit to execute any one of the application execution sets stored in the execution set storage.

A method for executing applications in a network system according to the present invention is a method for executing applications in a network system in which one or more application provider servers providing an application execution set that is a set of an application and one or more databases used on execution of the application and application execution units including a plurality of application execution environments that are formed of a container built for each application execution set as an operating environment for the application and a database engine accessing at least one of the databases based on operations of the application are connected through an external network and one of the application execution units and client terminals are connected through an internal network. The application execution unit includes: acquiring the application execution set from the application provider server; and storing a plurality of acquired application execution sets and executing the application execution set in each application execution environment based on an execution request from the client terminal.

With this configuration, an application execution environment is available to each application; therefore, even when a plurality of applications developed by a plurality of different vendors coexist and execute concurrently in a single application execution unit, execution results can be output to client terminals without causing trouble to each other. Even when a memory leak occurs in an application, for example, other applications do not stop running under the influence, because a separate memory region is assigned to each application execution environment. It is also possible to use different types of databases in a single application execution unit because each application execution environment includes a database engine to access the databases for each application.

It is also possible to facilitate a data acquisition operation by the application execution unit because a set of an application and databases is provided from the application provider server to the application execution unit.

In this situation, it is preferable that the application execution unit also include a linking application that describes linking relationships among a plurality of application execution sets, and execute the linking application in the application execution environment to link and execute a plurality of application execution sets in reply to an execution request from the client terminal.

With this configuration, it is possible to link and use a plurality of applications extensively and to prevent linked applications from causing trouble to each other. Linking the applications for business trip management and transportation schedules, for example, makes it possible to provide information on travel expenses incurred and transportation used on business trips. The linking application may be configured so as to be arranged in an application execution environment exclusive thereto, or in the application execution environment for another application.

In this situation, it is preferable that the application execution unit also include an alarm that determines whether an application execution environment to execute the application execution set exists when the execution set acquisitor acquires the application execution set from an application provider server, and gives notice that no application execution environment exists when it determines that.

With this configuration, when a plurality of application execution environments built in the application execution unit are all used by other application execution sets, a notice is given that there is no available application execution environment; this allows for replacement of application execution sets, addition of application execution environments or other earlier actions.

In this situation, it is preferable that the internal network be a LAN.

With this configuration, the internal network is configured as a LAN; this makes it possible to keep the speed of response from the application execution unit to a client terminal fast.

A feature of a computer according to the present invention is that it can serve as an application execution unit, administration server or application provider server used in the network system according to the present invention.

A feature of a program according to the present invention is that it causes computers to run every process included in the above method for providing applications in a network system or the above method for executing applications in a network system.

Use of the above makes it possible to provide a program that allows users to use application services in a simple configuration without being affected by server performance or connection quality.

### BRIEF DESCRIPTION OF THE DRAWINGS

FIG. 1 is a system configuration diagram of a network system.

FIG. 2 is a diagram showing an example of user information.

FIG. 3 is a diagram showing an example of application provider information.

FIG. 4 is a diagram showing an example of application usage information.

FIG. 5 is a diagram showing an example of an application catalog.

FIG. 6 is a control block diagram of a network system.

FIG. 7 is a function block diagram of a network system.

FIG. 8 is a diagram showing an example of a customized application catalog.

FIG. 9 is a flow chart showing processes of application acquisition by an application execution unit.

FIG. 10 is a flow chart showing processes of execution result acquisition by a client terminal.

FIG. 11 is a system configuration diagram of a network system according to a second embodiment of the present invention.

FIG. 12 is a control block diagram of a network system according to the second embodiment.

FIG. 13 is a schematic diagram showing an execution environment included in an application execution unit according to the second embodiment.

FIG. 14 is a function block diagram of a network system according to the second embodiment.

FIG. 15 is a flow chart showing processes for acquiring and executing an application execution set that are run by an application execution unit according to the second embodiment.

### REFERENCE NUMERALS

1 network system (first embodiment)

2 application provider server

3 administration server

4 application execution unit

5 client terminal

13 application usage information

14 application catalog

71 application catalog storage

72 application catalog sender

73 application usage information storage

74 rate information generator

81 application selector

82 application acquisitor

83 application storage

84 application executor

85 terminal executability information storage

86 terminal identifier

87 terminal executability determiner

88 terminal management information reviser

89 terminal management information storage

90 terminal management information sender

91 user executability information storage

92 user identifier

93 user executability determiner

94 user management information reviser

95 user management information storage

96 user management information sender

97 usage overview storage

98 usage overview sender

99 server execution requester

100 output data sender

101 execution requester

201 network system (second embodiment)

207 application

208 databases

209 application execution set

241 application execution environment

242 container

243 database engine

251 execution set acquisitor

252 execution set storage

253 execution set executor

254 alarm

255 execution requester

### BEST MODES FOR CARRYING OUT THE INVENTION

A network system, computers, and a method and program for providing and executing applications in such a network system according to embodiments of the invention will be described hereinafter with reference to the accompanying drawings.

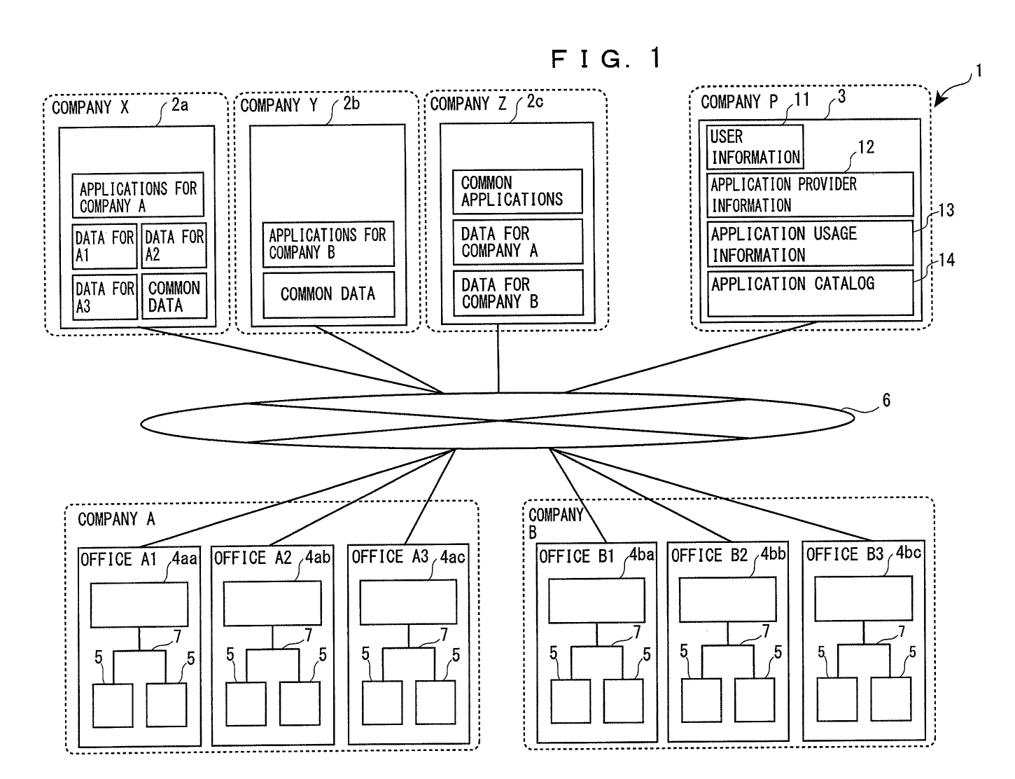

FIG. 1 is a system configuration diagram of a network system 1 according to an embodiment of the present invention. In the network system 1 according to an embodiment of the present invention, application provider servers 2a, 2b and 2c owned respectively by a plurality of application providers (Companies X, Y and Z) who provide applications, a single administration server 3 owned by a platform administrator (Company P) who administers the network system 1, and application execution units 4aa, 4ab, 4ac, 4ba, 4bb, and 4bc installed respectively in offices (Offices A1, A2, A3, B1, B2 and B3) of a plurality of users (Companies A and B) who use applications are connected through the Internet 6 (an external network); and each application execution unit 4 and client terminals 5 that request the application execution unit 4 to execute applications are connected through a local area network (LAN) 7 (an internal network) in each office.

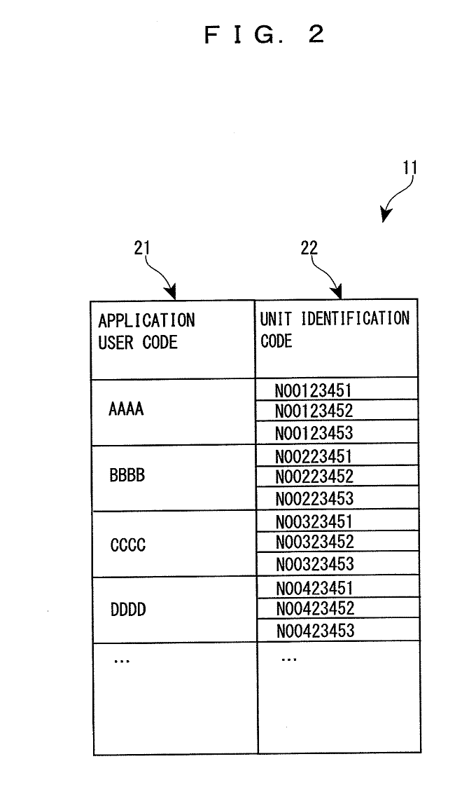

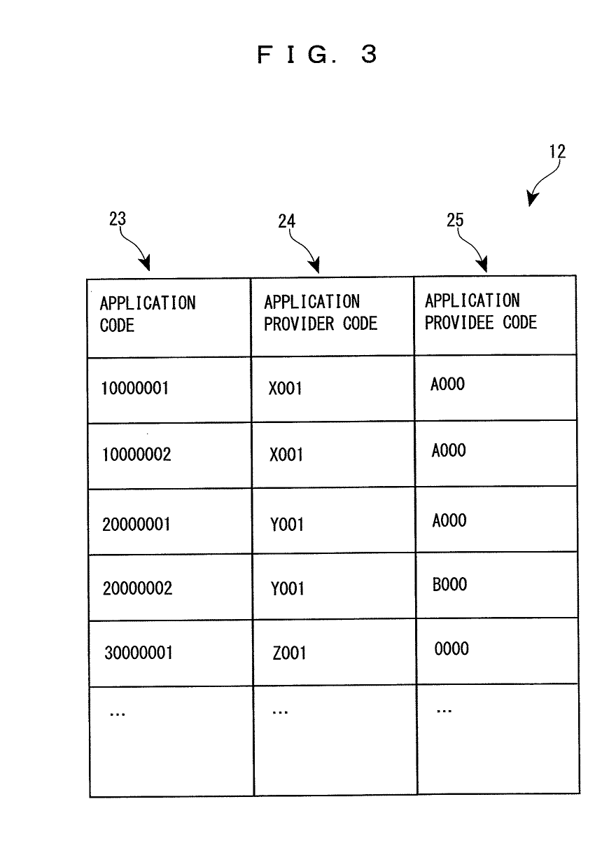

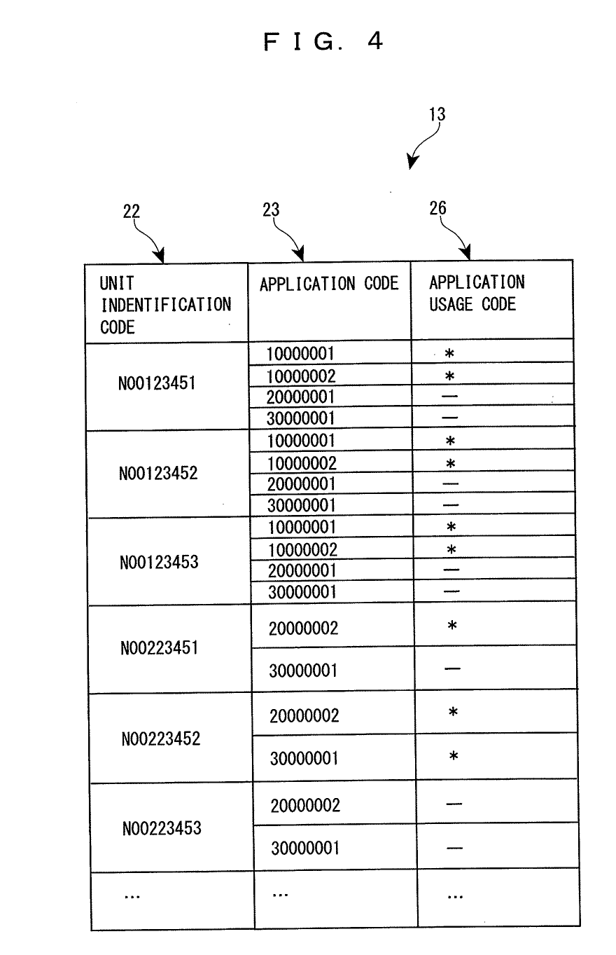

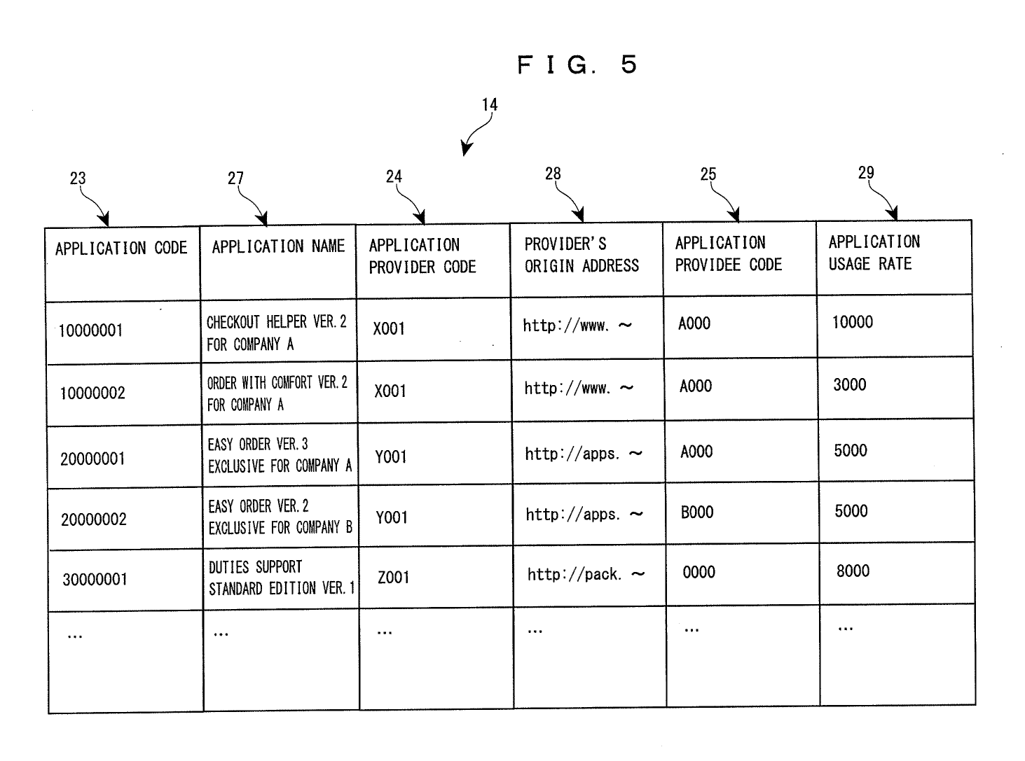

The administration server 3 is installed in a data center of Company P, for example, and serves as a receptionist in order for application providers to provide applications to users (application execution units 4). The administration server 3 stores user information 11, application provider information 12, application usage information 13 and an application catalog 14. The user information 11 is information associating application execution units 4 with users (as shown in FIG. 2). The application provider information 12 is information associating applications with application providers and application providees (as shown in FIG. 3). The application usage information 13 is information associating application execution units 4 provided with the applications with the applications used by the application execution units 4 (as shown in FIG. 4). The application catalog 14 lists applications provided by a plurality of application provider servers 2 (as shown in FIG. 5), and is provided to each application execution unit 4 by the administration server 3. This function allows users to select desired applications from the application catalog 14 and search for applications smoothly, and widens the selection of applications. What are called applications herein include not only so-called application programs but data used to update applications, resources, libraries and other data.

An application execution unit 4 is installed in each office of users', and executes applications in reply to execution requests from client terminals 5 located in each office. More specifically, the application execution unit 4 serves as a server for server-based computing (SBC), such as a housing service and hosting service. This provides a configuration that enables each client terminal 5 to acquire application execution results without having applications installed.

The user information 11, application provider information 12, application usage information 13 and application catalog 14 will be described hereinafter. As shown in FIG. 2, the user information 11 associates application user codes 21 with unit identification codes 22. The application user codes 21 are identification codes used to manage users on the administration server 3. In an example shown in the figure, “AAAA” represents Company A, and “BBBB” represents Company B, respectively. The unit identification code 22 is the serial number of an application execution unit 4. For example, an application execution unit 4aa installed in Office A1 of Company A is listed as N00123451. Instead of serial numbers, unique character strings or MAC addresses may be used as unit identification codes 22.

The application provider information 12 shown in FIG. 3 associates an application code 23 with an application provider code 24 and application providee code 25 for each application. The application code 23 is an identification code given to each application in order for the administration server 3 to manage applications. The application provider code 24 is an identification code given to each application provider. According to the embodiment of the present invention, the application provider code of Company X is X001; that of Company Y is Y001; and that of Company Z is Z001. The application provide code 25 is the identification code of a user who is a target provided with applications by an application provider. An application exclusive to Company A is listed as “A000”; an application exclusive to Company B as “B000”; and an application provided to all users as “0000.”

The application usage information 13 shown in FIG. 4 associates unit identification codes 22 with application codes 23 and application usage codes 26. The application usage information 13 associates the application code 23 of an application introducible to the application execution unit 4 corresponding to a serial number listed in the unit identification code 22. The application usage code 26 is an identification code showing whether the application has been actually introduced to the application execution unit 4. In the figure, the character “*” is listed when the application has been introduced; and the character “−” is listed when it has not. For example, introduced to the application execution unit 4 corresponding to the serial number N00123451 are the applications corresponding to the application codes 10000001 and 10000002.

The application catalog 14 will be described hereinafter with reference to FIG. 5. The application catalog 14 associates an application code 23 with an application name 27, application provider code 24, provider's origin address 28, application providee code 25 and application usage rate 29 for each application.

The application name 27 is the name of an application. The provider's origin address 28 is the URL of the application provider server 2 that stores the application. Listed in the application usage rate 29 is a monthly rate for application usage. The application usage rate 29 may be a usage rate per unit of time or of processed data volume instead of a monthly usage rate.

A sequence of processes run until a client terminal 5 receives an application execution result from an application execution unit 4 in the network system 1 will be briefly described hereinafter with reference to the system configuration diagram shown in FIG. 1. Since any office herein has the same basic configuration, Office A1 of Company A will be taken for example to provide a description. Firstly, Companies X, Y and Z send the administration server 3 the information of the applications to be provided in order to register the target applications on the administration server 3. Receiving it, the administration server 3 registers the information of each of Companies X, Y and Z's applications on itself. The administration server 3 creates an application catalog 14 from the registered information of each application and other information, and saves it.

The administration server 3 sends the saved application catalog 14 to the application execution unit 4aa on a regular basis or on the request of the application execution unit 4aa installed in Office A1. Through the operation of selecting a desired application from the application catalog 14, the application execution unit 4aa can download the desired application (e.g., Checkout Helper Ver. 2 for Company A) from a provider's origin, such as Company X's origin address 28 (the URL of an application provider server 2). The downloaded application is stored in the application execution unit 4aa. Then, the application execution unit 4 executes the application in reply to an execution request from a client terminal 5, and returns the execution result to the client terminal 5.

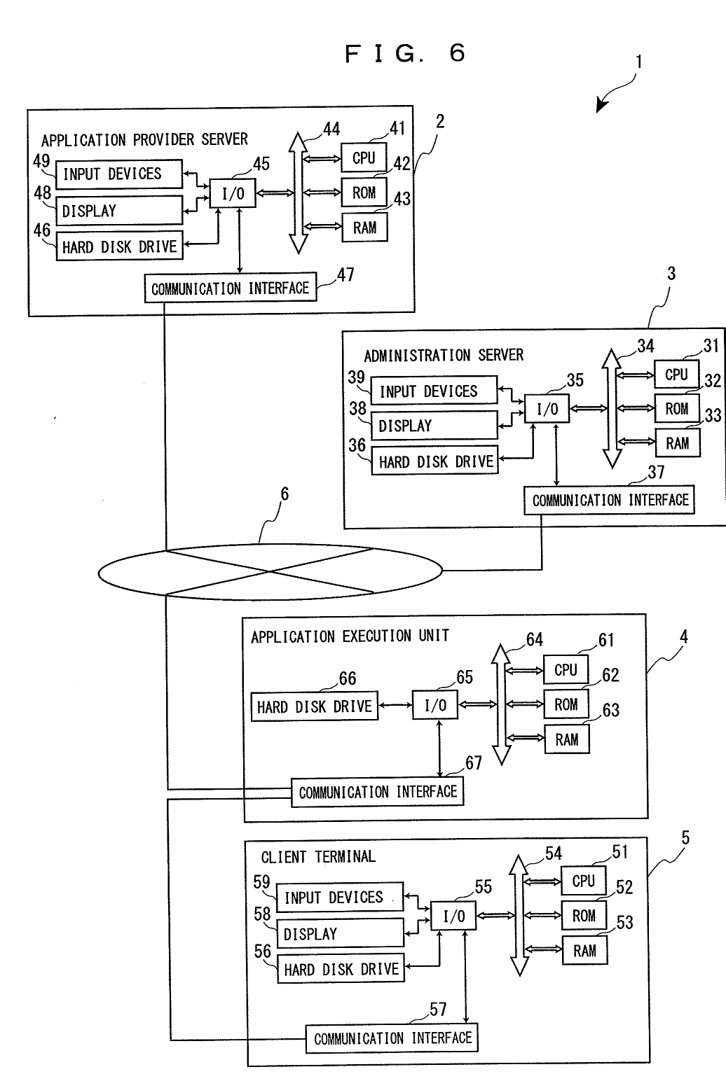

The control configuration of each unit (an application provider server 2, administration server 3, application execution unit 4 and client terminal 5) included in the network system 1 according to the embodiment of the present invention will be described hereinafter with reference to FIG. 6. Since an application provider server 2, the administration server 3 and a client terminal 5 have the same hardware configuration, the administration server 3 will be taken for example to provide a description. The administration server 3 includes a central processing unit (CPU) 31, read only memory (ROM) 32 and random access memory (RAM) 33, which are connected to an input-output interface 35 via internal buses 34. The ROM 32 stores a control program to control various processes run on the administration server 3 with the CPU 31, and also stores various control data.

The administration server 3 also includes a hard disk drive 36 and communication interface 37 that sends and receives data through the network such as a LAN 7 and the Internet 6; and they are connected directly to the input-output interface 35. The hard disk drive 36 stores an operating system and various applications.

The administration server 3 also includes input devices 39, such as a keyboard and mouse, and a display 38 that displays input data and execution results. Each of them is connected to the input-output interface 35.

Embedded in the input-output interface 35 are logic circuits that complement the functions of the CPU 31 and deal with interface signals from and to various peripheral circuits; they take into the internal buses 34 input and control data from the input devices 39 in original or processed form; and in tandem with the CPU 31, they also output to each component the data and control signals output from the CPU 31 to the internal buses 34 in original or processed form. With the above configuration, the CPU 31 inputs various signals and data from each component included in the administration server 3 through the input-output interface 35 according to the control program included in the ROM 32; and it exercises control over various processes by processing various data stored in the RAM 33 based on the variety of input signals and data and outputting various signals and data to each component included in the administration server 3 through the input-output interface 35.

Although an application execution unit 4 is different from any of the above units (an application provider server 2, administration server 3 and client terminal 5) in that it does not include input devices 39 nor a display 38, the rest of its control configuration is the same.

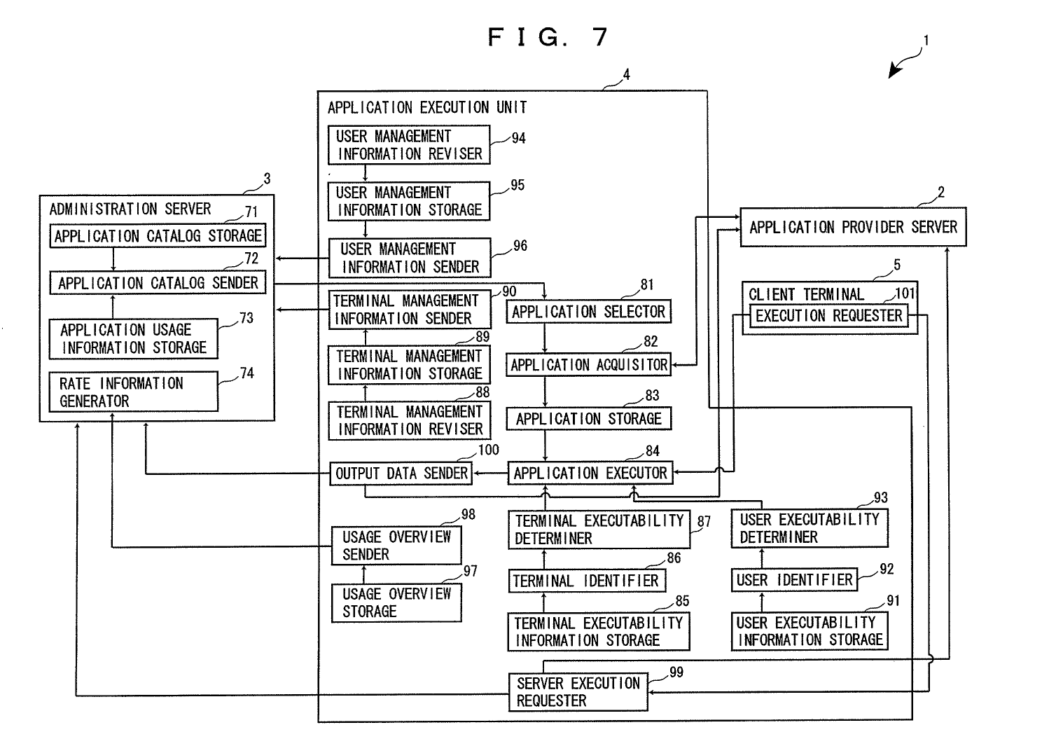

Processes for application acquisition and execution by an application execution unit 4 will be described hereinafter. FIG. 7 is a function block diagram of the network system 1 running the processes.

The administration server 3 includes an application catalog storage 71, application catalog sender 72, application usage information storage 73 and rate information generator 74.

The application catalog storage 71 stores the application catalog 14 described above. The application usage information storage 73 stores the application usage information 13 described above. Based on the application usage information 13, the application catalog sender 72 customizes the application catalog 14 stored in the hard disk drive 36 to list the only applications introducible to the application execution unit 4 that is sent the catalog (as described below); and it sends the customized application catalog 14 to the application execution unit 4. The rate information generator 74 generates rate information for each client terminal 5 based on a usage overview received from the application execution unit 4. Rate information may also be generated for each application execution unit 4.

The main part of the application catalog storage 71 and application usage information storage 73 is formed of a hard disk drive 36, for example. The application catalog sender 72 and rate information generator 74 are implemented in such a manner that the CPU 31 calculates various data according to the control program included in the ROM 32 and various programs installed in the hard disk drive 36, and runs processes in tandem with the input devices 39 and communication interface 37.

The configuration that allows the application catalog sender 72 to customize the application catalog 14 will be described hereinafter. When an application execution unit 4 makes a request to the administration server 3 for transmission of the application catalog 14, the administration server 3 identifies the serial number of the application execution unit 4 that has made the transmission request.

Next, the administration server 3 searches for application codes 23 corresponding to the serial number of the application execution unit 4 using the unit identification code 22 included in the application usage information 13 (shown in FIG. 4). If the application execution unit 4 is the unit installed in Office Al (and its serial number is N00123451), for example, the corresponding application codes 23 are “10000001,” “10000002,” “20000001” and “30000001.”

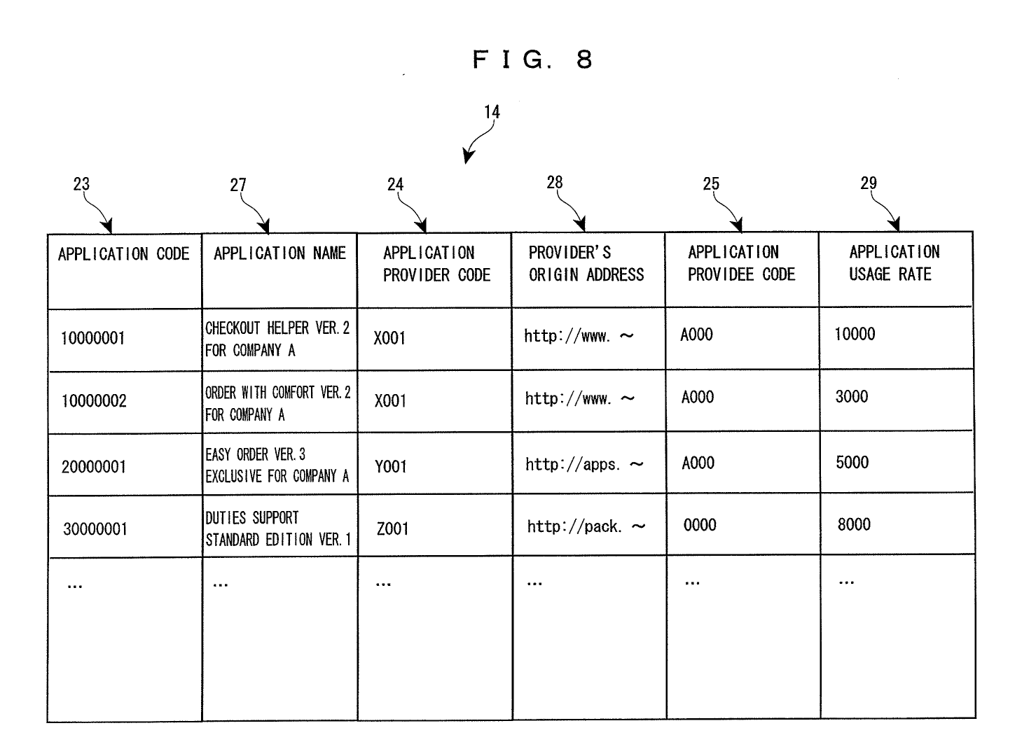

Lastly, the administration server 3 customizes the application catalog 14 by limiting the information to that corresponding to the acquired application codes 23. As a result, the application catalog 14 after customization is limited to the information corresponding to the application codes 23 for Company A (“10000001,” “10000002,” “20000001” and “30000001”), as shown in FIG. 8. The customized application catalog 14 is sent to the application execution unit 4 (whose serial number is N00123451) that is provided with applications. This allows a customized application catalog 14 to be sent, which provides a configuration that makes it easier for users to select desired applications.

An application execution unit 4 includes an application selector 81, application acquisitor 82, application storage 83, application executor 84, terminal executability information storage 85, terminal identifier 86, terminal executability determiner 87, terminal management information storage 89, terminal management information reviser 88, terminal management information sender 90, user executability information storage 91, user identifier 92, user executability determiner 93, user management information storage 95, user management information reviser 94, user management information sender 96, usage overview storage 97, usage overview sender 98, server execution requester 99 and output data sender 100.

The application selector 81 selects an application desired by a user from a plurality of applications listed in the application catalog 14 received from the administration server 3. For example, the application selector 81 selects an application based on the information input by a user with the input devices 59 of a client terminal 5. The application acquisitor 82 downloads the application selected by the application selector 81 from an application provider server 2 based on the application provider's origin address 28 listed in the application catalog 14. The application storage 83 stores the application acquired by the application acquisitor 82 on the hard disk drive 66. The application executor 84 executes the application stored by the application storage 83 in reply to an execution request from the client terminal 5.

An application execution unit 4 is configured so as to give precedence information on precedence in application execution to each application and have it stored by the application storage 83. In the precedence information, the precedence is identified by a flag or any other indication given to the application. With this configuration, the application executor 84 executes applications in order of precedence in execution even when requests for execution of a plurality of applications are made from client terminals 5 concurrently; for example, giving precedence in execution to an application that is used for more important processes allows an application execution unit 4 to run more important processes earlier even when too many execution requests are made.

An application execution unit 4 is also configured so as to be capable of extending a plurality of applications stored by the application storage 83 by linking and executing them (an application extender). For example, this makes it possible to link the applications for business trip management and transportation schedules and to provide an extended application that supplies information on travel expenses incurred and transportation used on business trips, which allows for extensive use of applications.

The terminal executability information storage 85 stores in the application storage 83 terminal executability information that defines application executability for each client terminal 5. The terminal executability information associates the IP address of a client terminal 5 with “executability” or “unexecutability” of an application. The terminal identifier 86 identifies a client terminal 5 that has made a request for application execution by the IP address of the origin of the request. The terminal executability determiner 87 determines executability of an application based on the terminal executability information and the IP address of the origin of the request. In short, the terminal executability information is information used to limit client terminals 5 that have access to an application; and it prevents unauthorized access from client terminals 5. This allows controlling applications executable for each client terminal 5, which enables each client terminal 5 to specialize in a particular function. A client terminal 5 may be configured so as to be identified by its MAC address or serial number instead of its IP address.

The terminal management information storage 89 stores a list of IP addresses of client terminals 5 connected to the LAN 7 in a user's office for terminal management information. Triggered by a change (disconnection or addition) of client terminals 5 included in the LAN 7, the terminal management information reviser 88 revises the terminal management information. The terminal management information reviser 88 may be configured so as to make a revision on a regular basis or on each execution request from a client terminal 5. The terminal management information sender 90 sends the terminal management information to the administration server 3 on a regular basis or on each revision. As described above, the administration server 3 oversees connections from client terminals 5 to the LAN 7 in each office. With this configuration, for example, the administration server 3 can detect that a client terminal 5 has been disconnected from the LAN 7 in an office. The administration server 3 can inform the user thereof, which allows for earlier troubleshooting. The terminal management information may be configured as a list of MAC addresses or serial numbers of all client terminals 5 instead of a list of their IP addresses. The terminal management information may also be configured so as to include the terminal executability information.

The user executability information storage 91 stores, in the application storage 83, user executability information that defines application executability for each user of a client terminal 5. The user executability information associates a user ID with “executability” or “unexecutability” of an application. The user identifier 92 identifies a client terminal 5 that has made a request for application execution by the user ID of the user who operates the client terminal 5. The user executability determiner 93 determines executability of an application based on the user executability information and user ID. In short, the user executability information is information used to control users who have access to an application; and it prevents unauthorized access from users. This allows controlling applications executable for each user, which makes it possible to construct a system that is flexible and independent from the use of client terminals 5.

The user management information storage 95 stores a list of user IDs accessing an application execution unit 4 for user management information. Triggered by a change (disconnection or addition) of users accessing the application execution unit 4, the user management information reviser 94 revises the user management information. The user management information reviser 94 may be configured so as to make a revision on a regular basis or on each execution request from a client terminal 5. The user management information sender 96 sends the user management information to the administration server 3 on a regular basis or on each revision. As described above, the administration server 3 oversees access from users to the application execution unit 4 in each office. With this configuration, it is possible to strictly manage application execution per user. The user management information may be configured so as to include the user executability information; or the terminal management information may be configured so as to include the terminal executability information, user management information and user executability information.

The usage overview storage 97 stores an overview of application usage by each client terminal 5 connected to the LAN 7 in a user's office on the hard disk drive 66. The usage overview sender 98 sends the usage overview stored on the hard disk drive 66 concurrently with the terminal management information and user management information to the administration server 3. Specifically, the usage overview is represented by the type of application used by a client terminal 5, the time duration of application usage and the volume of data processed in application usage.

When acquiring the information on the application used by each client terminal 5 from an application execution unit 4, for example, the administration server 3 has the rate information generator 74 calculate a monthly usage rate corresponding to the application type and manages it for rate information. As described above, the administration server 3 manages the rate information for each client terminal 5; therefore, when the rate is charged according to the usage time duration or processed data volume, for example, the administration server 3 can limit application usage by informing a client terminal 5 that has exceeded a given rate or taking any other action. In the above instance, the rate information is managed for each client terminal 5; however, it may be managed for each user. In other words, it is possible to adopt a configuration that allows sending the type of application used by a user, the time duration of application usage and the volume of data processed in application usage to the administration server 3 and depending on the information to manage the rate information.

Since it manages the rate information for applications used by each client terminal 5 and for each client terminal 5, the administration server 3 allows the platform administrator to pay the charges for application supply to the application providers. In other words, application providers can collect the charges for application supply from users via the platform administrator. This eliminates a need for application providers to manage the rate information, which can reduce their burden.

When a request for application execution is made from a client terminal 5, and the application specified in the execution request is a predetermined type of application and has been introduced to an application provider server 2 or the administration server 3, the server execution requester 99 sends an execution request to the application provider server 2 or administration server 3 instead of the client terminal 5. This means that an application execution unit 4 can change the destination of a request for application execution according to the application type (content of the processes to be run by the application are) or other factors. The information on the application type may be obtained by application execution units 4 beforehand, or be requested of a given server (the administration server 3 or an application provider server 2) on an execution request.

The output data sender 100 sends an application provider server 2 output data that are output by application execution. In this situation, the output data that are sent are received by the application provider server 2, which can use them for other processes in the application provider server 2. A client terminal 5 that is a POS terminal, for example, can send purchased item information output by POS application execution to the administration server 3 or application provider server to have it run sales management processes. The destination of output data may be the administration server 3 instead of an application provider server 2 in order to run processes on the administration server 3.

The main part of the application storage 83, terminal executability information storage 85, terminal management information storage 89, user executability information storage 91, user management information storage 95 and usage overview storage 97 is formed of the hard disk drive 66, for example. The application selector 81, application acquisitor 82, application executor 84, terminal identifier 86, terminal executability determiner 87, terminal management information reviser 88, terminal management information sender 90, user identifier 92, user executability determiner 93, user management information reviser 94, user management information sender 96, usage overview sender 98, server execution requester 99 and output data sender 100 are implemented in such a manner that the CPU 61 calculates various data according to the control program included in the ROM 62 and various programs installed in the hard disk drive 66, and runs processes in tandem with the communication interface 67.

A client terminal 5 includes an execution requester 101. The execution requester 101 requests application execution of an application execution unit 4. The execution requester 101 is implemented in such a manner that the CPU 51 calculates various data according to the control program included in the ROM 52 and various programs installed in the hard disk drive 56, and runs processes in tandem with the input devices 59 and communication interface 57.

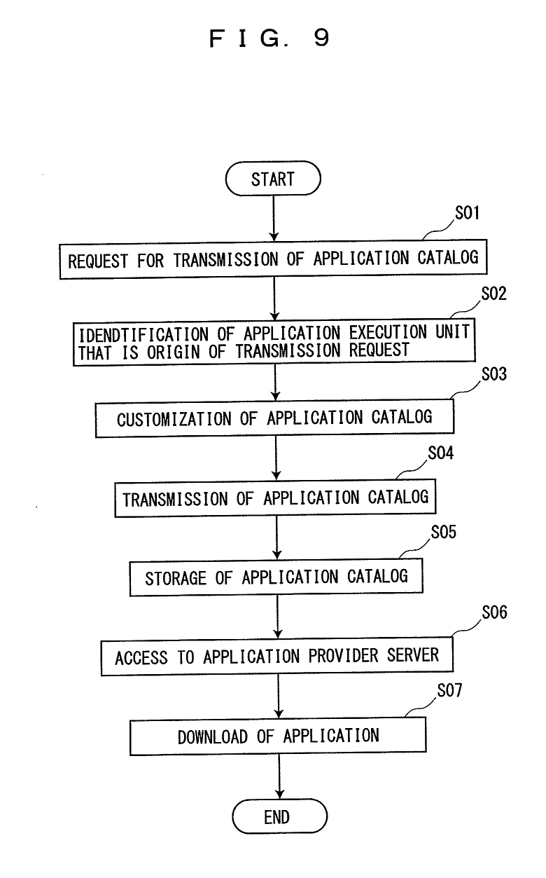

A sequence of processes run until an application execution unit 4 acquires an application will be specifically described hereinafter with reference to FIG. 9. Firstly, an application execution unit 4 makes a request to the administration server 3 for transmission of the application catalog 14 (S01). Receiving the transmission request, the administration server 3 identifies the application execution unit 4 that is the origin of the transmission request (S02). The administration server 3 customizes the application catalog 14 based on the application usage information 13 (S03), and sends the customized application catalog 14 to the application execution unit 4 that has made the transmission request (S04).

Receiving the application catalog 14, the application execution unit 4 stores it on the hard disk drive 66 (S05). The application execution unit 4 accesses the URL of the application provider server 2 that stores an application selected by a user from the application catalog 14 (S06). Lastly, the application execution unit 4 downloads the application from the application provider server 2 and stores it on its hard disk drive 66 (S07).

It is possible to replace the embodiment with a configuration that allows an application execution unit 4 to acquire an application selected by an application selector agent included in the administration server 3. The application selecting agent has the administration server 3 select an application in place of the application selector 81 included in an application execution unit 4. With the application selecting agent, an application execution unit 4 automatically acquires an application selected by the administration server 3, which saves a user selecting an application. This also allows the administration server 3 to manage applications to be introduced to the application execution units 4. The information on application selections by the application selecting agent may be sent by the administration server 3 concurrently with the application catalog 14 or as an inclusion in the application catalog 14.

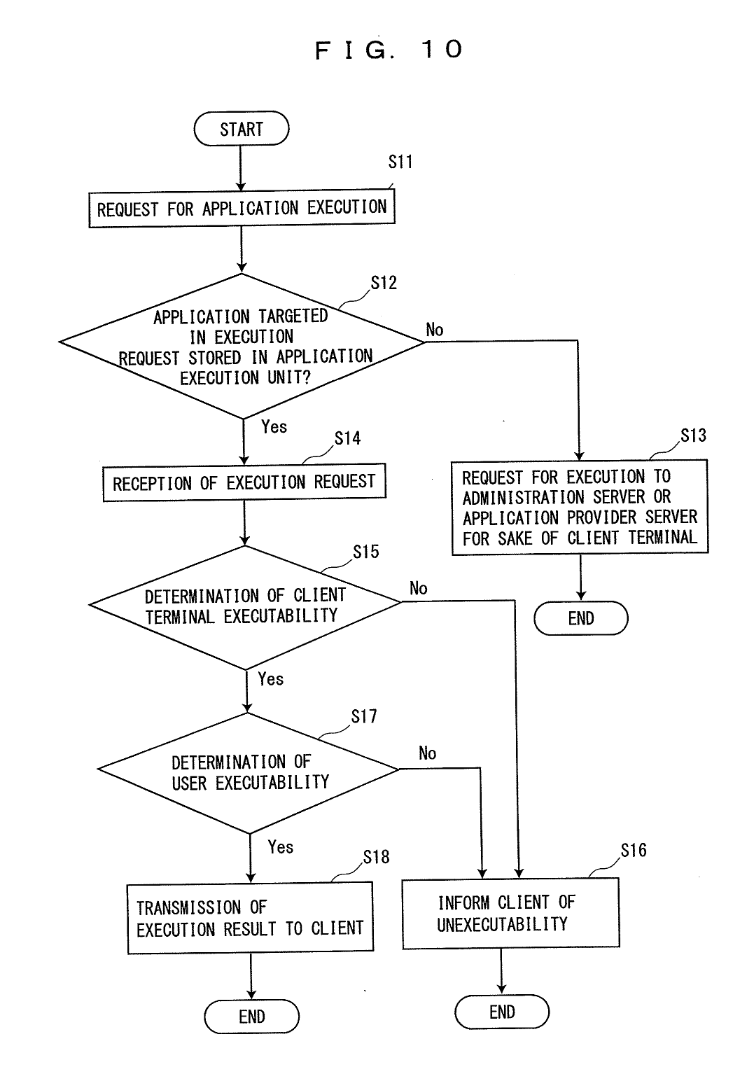

Next, in accordance with the request from a client terminal 5, a sequence of processes run until an application execution unit 4 executes an application and returns an execution result will be specifically described hereinafter with reference to FIG. 10. Firstly, the client terminal 5 makes a request to an application execution unit 4 for application execution (S11). The application execution unit 4 determines which of the application execution unit 4 (itself), the administration server 3 and an application provider server 2 stores the application to be subject to execution (S12). When the administration server 3 or application provider server 2 stores the application (S12: No), the application execution unit 4 makes an execution request to the administration server 3 or application provider server 2 in place of the client terminal 5 (S13). On the other hand, when the application execution unit 4 stores the application (S12: Yes), it receives the execution request (S14).

As described above, an application execution unit 4 changes processes according to the application type, which configures an optimized execution environment in the network system 1. For example, the requests that need to be processed by the administration server 3 in real time are fulfilled by the administration server 3; and those which do not need to can be processed by an application execution unit 4. In this situation, the response speed between a client terminal 5 and application execution unit 4, which are connected through a LAN 7, is high enough to run processes efficiently.

Receiving an execution request from a client terminal 5, the application execution unit 4 determines executability for the client terminal 5 based on the terminal executability information (S15). Determining that it is “unexecutable” (S15: No), the application execution unit 4 informs the client terminal 5 thereof without conducting execution (S16). On the other hand, determining that it is “executable” (S15: Yes), the application execution unit 4 determines executability for the user based on the user executability information (S17). Determining that it is “unexecutable” (S17: No), the application execution unit 4 informs the client terminal 5 thereof without conducting execution of the application (S16). Determining that it is “executable,” the application execution unit 4 executes the application and returns an execution result to the client terminal 5 (S18).

As described above, a network system 1 according to the embodiment allows client terminals 5 to acquire application execution results by accessing an application execution unit 4 connected through a LAN 7 without going through the Internet 6. This allows limiting an application execution environment to the LAN 7, which makes it possible to execute applications in a stable environment. This means that there is no need to adopt a redundant configuration with failures taken into consideration, which eliminates a need to construct a complicated network system 1 and reduces equipment costs.

Applications may be replaced with device drivers controlling devices (a printer and other peripheral devices). When a client terminal 5 is a POS terminal and a peripheral device is a receipt printer dispending receipts, for example, this configuration links a POS application and printer driver operating in an application execution unit 4, and allows the printer driver to receive a print command from the POS application, convert it to a process command that can be processed by the receipt printer, and send it to the receipt printer. The POS terminal, therefore, can print receipts through the application execution unit 4 without the device driver for the receipt printer installed. Since the configuration does not depend on an OS installed in a client terminal 5, users can choose freely not only a PC but an embedded device or mobile device as a client terminal 5. The configuration also eliminates a need for device driver providers to provide device drivers for various OSs, which saves efforts and costs spent for device driver development.

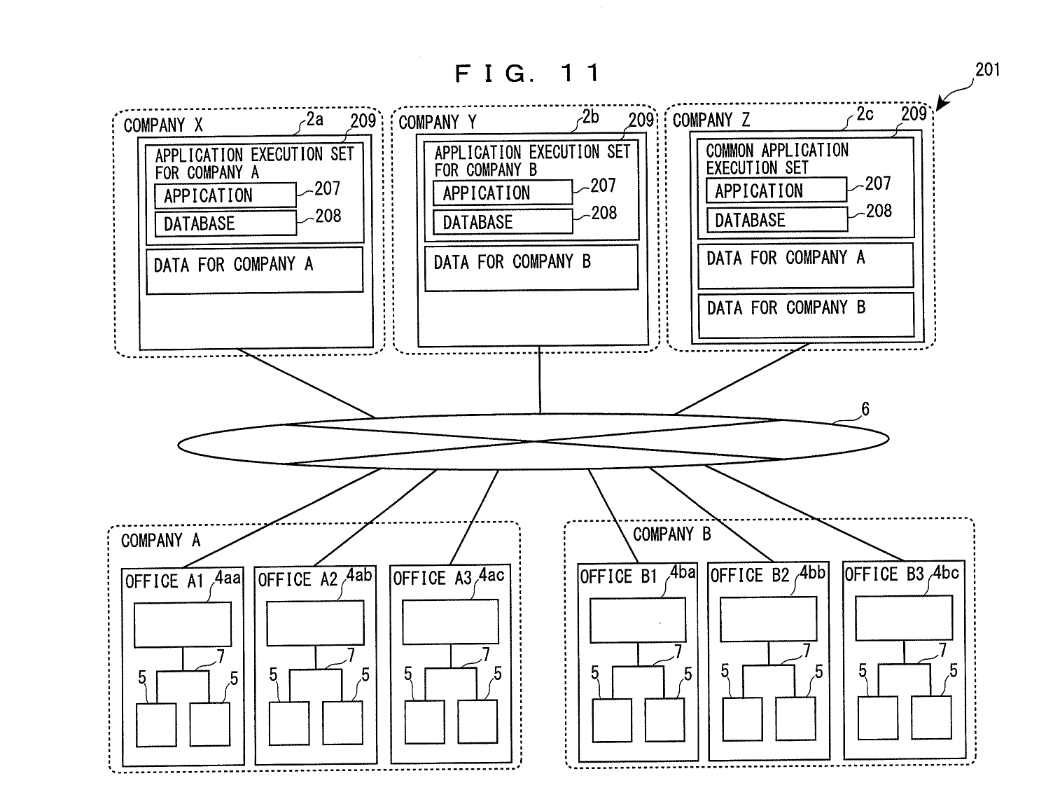

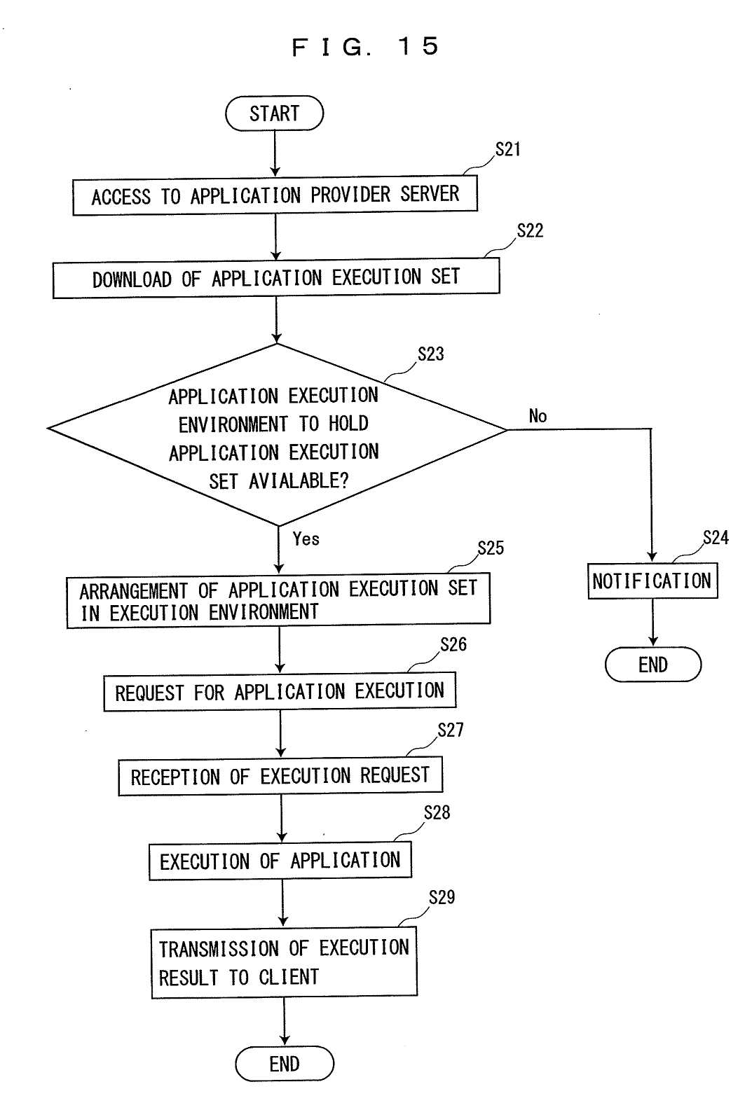

A second embodiment of the present invention will be described hereinafter with reference to FIG. 11 or 15. A feature of a network system 201 according to the embodiment is that application execution units 4 have execution environments corresponding to any applications and databases provided by a plurality of vendors.

FIG. 11 is a system configuration diagram of a network system 201 according to the second embodiment of the present invention. In the network system 201 according to the embodiment, application provider servers 2a, 2b and 2c owned respectively by a plurality of vendors (Companies X, Y and Z) that provide an application execution set 209—a set of an application 207 and one or more databases 208 used when the application 207 is executed, and application execution units 4aa, 4ab, 4ac, 4ba, 4bb, and 4bc installed respectively in offices (Offices A1, A2, A3, B1, B2 and B3) of a plurality of users (Companies A and B) who use the application execution set 209 are connected through the Internet 6 (an external network); and each application execution unit 4 and two client terminals 5 that request the application execution unit 4 to execute the application 207 are connected through a LAN 7 (an internal network) in an office.

An application provider server 2 provides an application execution set 209 in reply to the request of an application execution unit 4. What is called an application execution set 209 herein includes not only an application 207 and databases 208 but data used to update the application 207 and databases 208 and other data. Each application 207 and each databases 208 have been created under a development environment that varies from vender to vender.

An application execution unit 4 is installed in each office of users', and executes an application execution set 209 downloaded from an application provider server 2 in reply to execution requests from client terminals 5 located in each office. More specifically, an application execution unit 4 serves as a server for server-based computing (SBC), such as a housing service and hosting service, in an office. This provides a configuration that enables each client terminal 5 to acquire an execution result from an application 207 without having the application 207 installed.

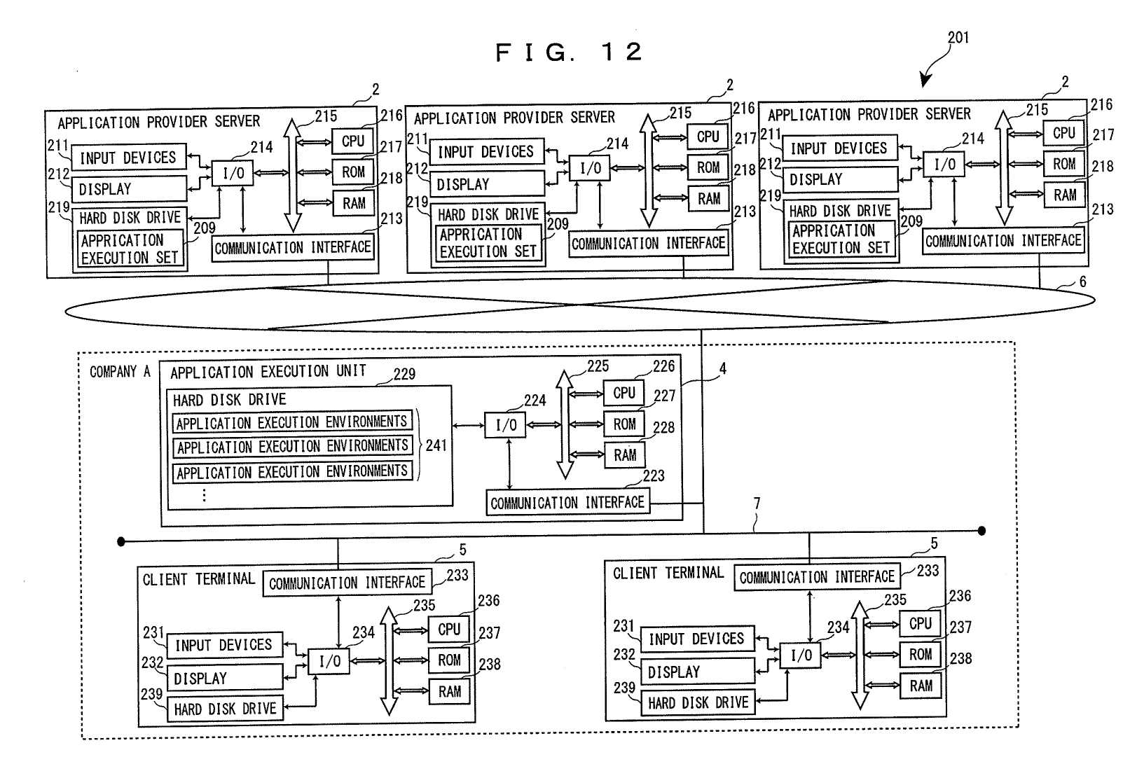

The control configuration of each unit (an application provider server 2, application execution unit 4 and client terminal 5) included in the network system 201 according to the embodiment of the present invention will be described hereinafter with reference to FIG. 12. Since an application provider server 2 and client terminal 5 have the same hardware configuration, an application provider server 2 will be taken for example to provide a description.

An application provider server 2 is the same as so-called regular computers, and includes input devices 211, a display 212, communication interface 213, input-output interface 214, internal buses 215, central processing unit (CPU) 216, read only memory (ROM) 217, random access memory (RAM) 218 and hard disk drive (HDD) 219. The HDD 219 stores an operating system (not shown) and an application execution set 209 provided to application execution units 4. Not limited to a personal computer, a client terminal 5 may be any type of printer, such as a receipt dispenser, or a mobile information terminal.

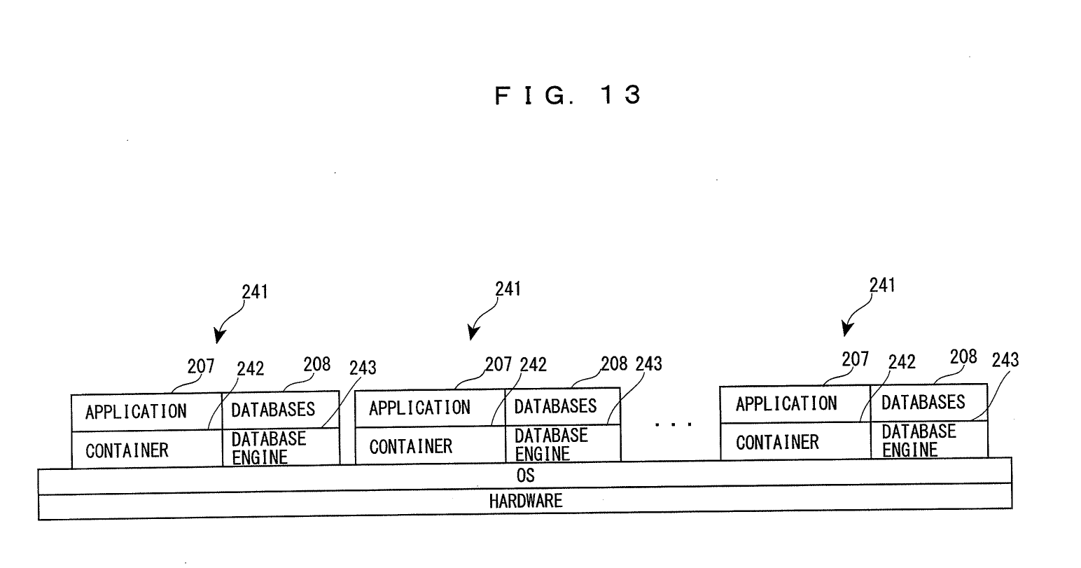

Although an application execution unit 4 is different from any of the above units (an application provider server 2 and client terminal 5) in that it does not include input devices 211 nor a display 212, the rest of its control configuration is the same. The HDD 229 included in an application execution unit 4 stores a plurality of application execution environments 241 that have been developed in order to execute application execution sets 209. Each application execution environment 241 includes a container 242 that is an operating environment to run an application 207, and a database engine 243 used to access databases 208 when an application 207 is used (as shown in FIG. 13). Resources, such as a memory region of the RAM 228, are assigned to each application execution environment 241; therefore, even when a memory leak occurs, for example, the application execution set 209 arranged in another application execution environment 241 does not stop running under the influence.

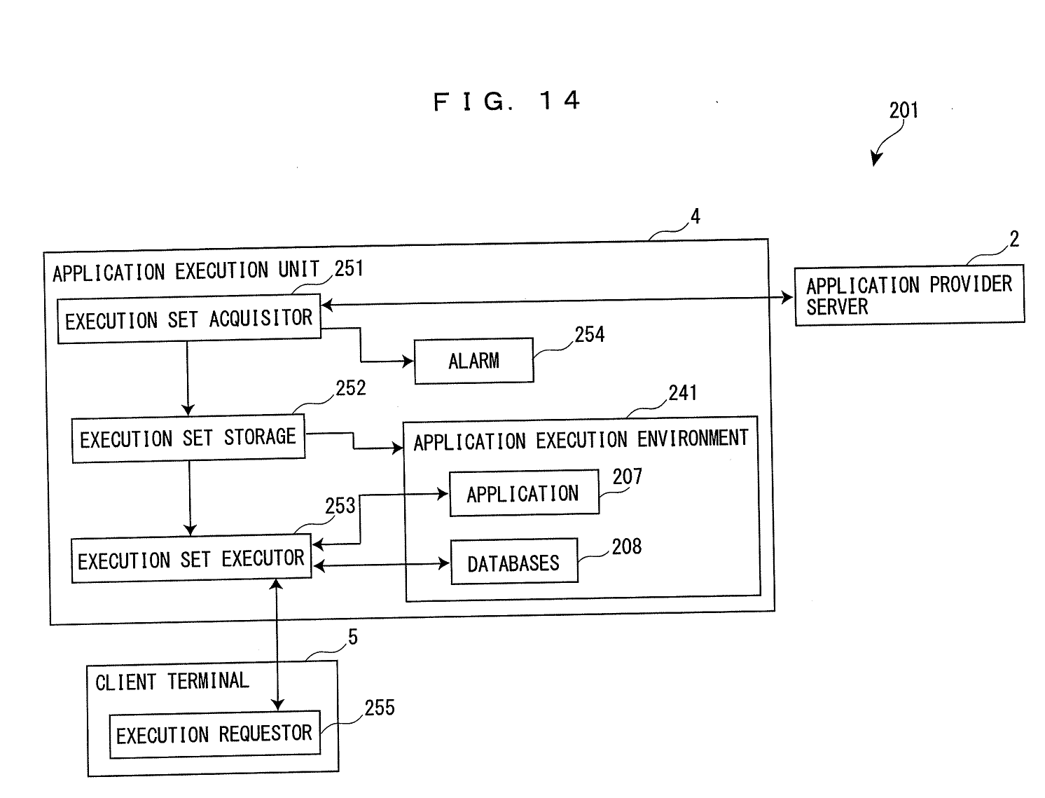

The functional configuration of the network system 201 will be described hereinafter with reference to FIG. 14.

An application execution unit 4 includes an execution set acquisitor 251, execution set storage 252, execution set executor 253 and alarm 254.

The execution set acquisitor 251 specifies the URL of an application provider server 2 and downloads an application execution set 209 from the application provider server 2. The execution set storage 252 associates the application execution set 209 acquired by the execution set acquisitor 251 with an application execution environment 241 and stores it on the HDD 229. This means that the application execution 4 associates the acquired application execution set 209 with each application execution environment 241 and stores it with an application 207 set in a container 242 and databases 208 set in a database engine 243 (as shown in FIG. 13).

The execution set executor 253 executes the application execution set 209 in the application execution environment 241 in reply to an execution request from a client terminal 5. The execution set executor 253 has a configuration that allows a program included in the application 207 to be read out on the execution of the application execution set 209 and allows an execution result to be output based on the content described in the program with reference to the database 208. When the downloaded application execution set 209 is stored on the HDD 229 and all application execution environments 241 are used by other application execution sets 209, the alarm 254 displays on the display 232 of the client terminal 5 the information that no application execution environment 241 to be associated with the application execution set 209 is available. This allows for replacement of application execution sets 209, addition of application execution environments 241 or other earlier actions. If the application execution unit 4 is equipped with a lamp or speaker, the alarm 254 may have a configuration that gives a visual display using a lamp indication or inform with a speaker sound (beep).

The main part of the execution set storage 252 is formed of the HDD 229, for example. The execution set acquisitor 251 and execution set executor 253 are implemented in such a manner that the CPU 226 calculates various data according to the control program included in the ROM 227 and various programs installed in the HDD 229, and runs processes in tandem with the communication interface 223. The alarm 254 is implemented in such a manner that the CPU 226 calculates various data according to the control program included in the ROM 227 and various programs installed in the HDD 229, and runs processes in tandem with the communication interface 223, the display 232 of a client terminal 5 and the communication interface 233.

A client terminal 5 includes an execution requester 255. The execution requester 255 requests the application execution unit 4 to execute the application 207. The execution requester 255 is implemented in such a manner that the CPU 236 calculates various data according to the control program included in the ROM 237 and various programs installed in the HDD 239, and runs processes in tandem with the input devices 231 and communication interface 233.

A sequence of processes of acquiring and executing an application execution set 209 at an application execution unit 4 will be described hereinafter with reference to the flow chart shown in FIG. 15. Firstly, an application execution unit 4 accesses the URL of the application provider server 2 that stores a desired application execution set 209 based on a download request from a client terminal 5 (S21). Next, the application execution unit 4 downloads the application execution set 209 from the application provider server 2 (S22). When no application execution environment 241 to arrange the downloaded application execution set 209 is left in the application execution unit 4 (S23: No), the application execution unit 4 displays the information on the display 232 of the client terminal 5 (S24). On the other hand, when the application execution environment 241 is left (S23: Yes), the application execution unit 4 associates the downloaded application execution set 209 with the application execution environment 241 and stores it on its HDD 229 (S25).

When the client terminal 5 requests the application execution unit 4 to execute an application 207 (S26), the application execution unit 4 receives the execution request (S27) and executes the application execution set 209 in the application execution environment 241 in which the application execution set 209 that are subject to execution is arranged (S28). Lastly, the application execution unit 4 sends an execution result to the client terminal 5 (S29).

At this point, the application execution unit 4 may be configured so as to execute a linking application. A linking application is an application to link and execute an application 207 and another application 207, and is described in WSDL form. The application execution unit 4 accesses each application 207 with reference to the linkage information described in the linking application. The linkage information is such information as commands defined in each application 207. Execution of the linking application allows linking and extensively using a plurality of applications 207 and does not allow linked applications 207 to cause trouble to each other. Linking the applications 207 for business trip management and transportation schedules, for example, makes it possible to provide information on travel expenses incurred and transportation used on business trips. The linking application may be configured so as to be arranged in an application execution environment 241 exclusive thereto, or in the application execution environment 241 for another application 207.

It is possible to adopt a configuration that defines executability of applications 207 for each user or client terminal 5. When executability of applications 207 is controlled for each user, the information associating user IDs with “executability” or “unexecutability” of applications 207 is stored in the application execution unit 4; and based on the information, the users who have access to the applications 207 are controlled. This allows preventing unauthorized access from users and assigning an application execution environment 241 exclusive to each user inside the application execution unit 4.

When executability of applications 207 is controlled for each client terminal 5, the information associating IDs for identification of client terminals 5 with “executability” or “unexecutability” of applications 207 is stored; and based on the information, the client terminal 5 that have access to the applications 207 are controlled. This allows preventing unauthorized access from client terminals 5, having each client terminal 5 specialize in a specific function and assigning an application execution environment 241 exclusive to each client terminal 5 inside the application execution unit 4. Instead of IDs for identification, IP addresses or MAC addresses may be used.

The network system 201 may be configured so as to have an administration server that serves as a receptionist for application provider servers 2 (vendors) to provide application execution sets 209 to application execution units 4 (users). In this situation, application execution units 4 (users) acquire from the administration server the information on each of the application execution sets 209 provided by a plurality of vendors, and download an application execution set 209 from an application provider server 2 based on the information. This configuration allows users to acquire the information on application execution sets 209 through the administration server without accessing a plurality of application execution units 4 individually and to search for an application execution set 209 smoothly.

According to the second embodiment, an application execution environment 241 is available to each application 207; therefore, even when a plurality of applications 207 developed by a plurality of different vendors coexist and execute concurrently in a single application execution unit 4, execution results can be output to client terminals 5 without causing trouble to each other. Even when a memory leak occurs in an application 207, for example, other applications 207 do not stop running under the influence, because a separate memory region is assigned to each application execution environment 241. It is also possible to use different types of databases 208 in a single application execution unit 4 because each application execution environment 241 includes a database engine 243 to access the databases 208 for each application 207.

It is also possible to facilitate an acquisition operation by an application execution unit 4 because a set of an application 207 and databases 208 is provided from an application provider server 2 to an application execution unit 4.

The two embodiments are described above; and each part (each function) of the network systems 1 or 201 according to the embodiments can be provided as a program. Such a program can be provided in a storage medium (not shown). As storage media, CD-ROM, flash ROM, memory cards (e.g., CompactFlash (registered trademark), SmartMedia, Memory Stick), magneto-optical disks, digital versatile discs, flexible disks or other storage media can be used.

Despite the above embodiments, appropriate changes and modifications to the system configurations or operation processes of the network systems 1 and 201 may be made without deviating from the scope of the invention.

1. A network system in which one or more application provider servers providing applications, application execution units executing the applications acquired from the application provider servers and a single administration server managing the application provider servers and the application execution units remotely are connected through an external network and one of the application execution units and client terminals requesting the application execution unit to execute the applications are connected through an internal network, wherein
the administration server provides the application execution units with information on the applications provided from the application provider servers; and
the application execution unit selects a desired application based on the information on the applications acquired from the administration server and executing the desired application based on a request from one of the client terminals.

2. The network system according to claim 1, wherein
the administration server includes an application catalog storage storing an application catalog that lists the plurality of applications provided from the application provider servers as information relating to the applications, and an application catalog sender sending the application catalog to the application execution units; the application execution unit includes an application selector selecting any one of the applications from the plurality of applications that are listed in the application catalog received from the administration server, an application acquisitor acquiring the application selected by the application selector from the application provider server, an application storage storing the application acquired and an application executor executing any one of the applications that are stored in the application storage; and the client terminal includes an execution requester requesting the application execution unit to execute any one of the applications stored in the application storage.

3. The network system according to claim 1, wherein
the administration server is connected with the plurality of application execution units for respective users, and the administration server further includes an application usage information storage storing application usage information that associates a given application out of the plurality of applications provided from the application provider servers with the application execution units that are the destinations of the application; and based on the application usage information, the application catalog sender sends the application execution units the application catalog that varies from user to user.

4. The network system according to claim 1, wherein
the administration server further includes an application selecting agent that selects the application in place of the application selector included in the application execution unit; and the application acquisitor included in the application execution unit acquires the application selected by the application selecting agent.

5. The network system according to claim 1, wherein
the application execution unit further includes a terminal executability information storage storing terminal executability information that defines executability of the application for each of the client terminals, a terminal identifier identifying the client terminal that has requested execution of the application and a terminal executability determiner determining executability of the application based on the terminal executability information and an identification result given by the terminal identifier; and the application executor executes the application only when the terminal executability determiner determines that it is executable.

6. The network system according to claim 1, wherein
the application execution unit further includes a terminal management information storage storing terminal management information of the client terminals connected to the same internal network, a terminal management information reviser revising the terminal management information when a change of the client terminals connected to the internal network occurs and a terminal management information sender sending the terminal management information to the administration server.

7. The network system according to claim 1, wherein
the application execution unit further includes a user executability information storage storing user executability information that defines executability of the application for each user of the client terminal, a user identifier identifying a user who has requested execution of the application and a user executability determiner determining executability of the application based on the user executability information and an identification result given by the user identifier; and the application executor executes the application only when the user executability determiner determines that it is executable.

8. The network system according to claim 1, wherein
the application execution unit further includes a user management information storage storing user management information of users using the application, a user management information reviser revising the user management information when a change of users occurs and a user management information sender sending the user management information to the administration server.

9. The network system according to claim 1, wherein
the application execution unit further includes a usage overview storage storing an overview of usage of the application by the client terminals connected to the same internal network and a usage overview sender sending the overview of usage of the application to the administration server.

10. The network system according to claim 9, wherein
the administration server further includes a rate information generator generating rate information for each of the users based on the overview of usage of the application that has been received.

11. The network system according to claim 1, wherein
each of the applications stored in the application storage is given precedence information on precedence in execution of the application; and the application executor executes the applications in order based on the precedence information when requests for execution of the plurality of applications are made from the client terminals.

12. The network system according to claim 1, wherein
the application execution unit further includes an application extender extending the plurality of applications acquired by the application acquisitor by linking and executing them.

13. The network system according to claim 1, wherein
the application executor further includes an output data sender sending the application provider server or the administration server output data that are output through execution of the application by the application executor.

14. The network system according to claim 1, wherein
the application execution unit further includes a server execution requester requesting a given server to run processes.

15. The network system according to claim 1, wherein
the application plays a role of a device driver.

16. The network system according to claim 1, wherein
the application provider server provides an application execution set that is a set of the application and one or more databases used on execution of the application; the application execution unit further includes an execution set acquisitor acquiring the application execution set from the application provider server, an execution set storage storing a plurality of application execution sets acquired, a plurality of application execution environments that are formed of a container built for each of the application execution sets as an operating environment for the application and a database engine accessing at least one of the databases based on operations of the application and an execution set executor executing in each of the application execution environments the application execution set stored in the application storage; and the client terminal includes an execution requester requesting the application execution unit to execute any one of the application execution sets stored in the execution set storage.

17. The network system according to claim 16, wherein
the application execution unit further includes a linking application that describes linking relationships among the plurality of application execution sets, and executes the linking application in the application execution environment to link and execute the plurality of application execution sets in reply to an execution request from the client terminal.

18. The network system according to claim 16, wherein
the application execution unit further includes an alarm that determines whether an application execution environment to execute the application execution set exists when the execution set acquisitor acquires the application execution set from an application provider server, and gives notice that no application execution environment exists when it determines that.

19. The network system according to claim 1, wherein
the internal network is a LAN.

20. A computer that serves as the application execution unit, the administration server or the application provider server used in the network system according to claim 1.

21. A method for providing applications in a network system in which one or more application provider servers that provide applications, application execution units that execute the applications acquired from the application provider servers and a single administration server that manages the application provider servers and the application execution units remotely are connected through an external network, one of the application execution units and client terminals are connected through an internal network and the administration server stores an application catalog listing information on the plurality of applications provided from the application provider servers, wherein
the administration server sends the application catalog to the application execution unit;
the application execution unit selects any one of the applications from the plurality of applications listed in the application catalog that is received from the administration server and acquires from the application provider server the application selected; and
the application execution unit stores the application acquired and executes the application stored based on an execution request from one of the client terminals.

22. A method for executing applications in a network system in which one or more application provider servers providing an application execution set that is a set of an application and one or more databases used on execution of the application and application execution units including a plurality of application execution environments that are formed of a container built for each application execution set as an operating environment for the application and a database engine accessing at least one of the databases based on operations of the application are connected through an external network and one of the application execution units and client terminals are connected through an internal network, wherein
the application execution unit comprises:
acquiring the application execution set from the application provider server; and
storing a plurality of acquired application execution sets and executes the application execution set in each of the application execution environments based on an execution request from one of the client terminals.

23. A program that causes computers to run every process included in the method of claim 21.

24. A program that causes computers to run every process included in the method of claim 22.
